(19) United States
(12) Patent Application Publication
(10) Pub. No.: US 2001/0002609 A1
(43) Pub. Date: Jun. 7, 2001

(54) METHOD OF MANUFACTURING REINFORCED WOOD COMPOSITES

(76) Inventors: HABIB DAGHER, VEZIE, ME (US); BECKRY ABDEL-MAGID, WINONA, MN (US)

Correspondence Address: MICHAEL J PERSSON, ESQ., LAWSON, PHILPOT & PERSSON, P.C., 67 WATER STREET; SUITE 110, LACONIA, NH, 03246, US

(21) Appl. No.: 09/135,374

(22) Filed: Aug. 17, 1998

(51) Int. Cl. B32B 5/00; B32B 29/02; C09J 5/02

(52) U.S. Cl. 156/176; 156/180; 156/307.4

(57) ABSTRACT

The present invention is method of making a fiber-reinforced polymer (FRP) used to reinforce a wood composite member, in which the FRP may be consolidated and substantially cured at the same time as the wood-wood bond lines. The method of manufacturing partially cured FRP composites of the present invention includes drawing fiber reinforcements in tension, combining the reinforcements into a dry fiber reinforcement layer, wetting the dry fiber reinforcement layer with a wet resin to form a wetted fiber reinforcement layer, and partially curing the wetted fiber reinforcement layer to form a partially cured FRP composite for consolidation and substantially simultaneous curing an uncured wood composite. The method of manufacturing reinforced wood composites of the present invention includes the aforementioned steps plus the steps of introducing the partially cured FRP composite into an uncured wood composite laminate, consolidating the FRP-wood laminate, and curing the consolidated laminate to form a reinforced wood composite.

### FIELD OF THE INVENTION

The invention relates to fiber-reinforcement polymers (hereafter FRP) for the reinforcement of wood and wood composite structural members to improve their strength, stiffness and ductility and reduce their creep. In particular, the present invention is directed to mostly unidirectional fiber-reinforced polymers that are processed and cured simultaneously with the adhesive used to bond the wood layers making up the wood composite structural members.

### BACKGROUND OF THE INVENTION

FRP-wood hybrids offer considerable potential for widespread use in construction and infrastructure applications. In addition to increasing the strength, stiffness and ductility of engineered wood composites, the hybrids allow for the utilization of low-grade lumber in construction. FRP-wood hybrids also offer flexibility in design allowing for longer spans, smaller profiles, and lighter structures. One important factor in developing this hybrid technology is to provide adequate bond strength and durability between the FRP reinforcement and the wood.

Studies conducted over the past six years by the inventors and others have shown the significant promise of combining wood and FRP. The inventor's studies have revealed, for example, that Glass Fiber Reinforced Polymer (GFRP) reinforcement in the order of 3% can increase the bending strength of wood beams by over 110%.

The idea of reinforcing wood is not new. Many studies on wood reinforcement have been performed in the last 40 years. Often metallic reinforcement was used including steel bars, prestressed strand cables, and stressed or unstressed bonded steel and aluminum plates. While significant increases in strength and stiffness have been achieved, the problems encountered were generally related to incompatibilities between the wood and the reinforcing material. Wood beams reinforced with bonded aluminum sheets experienced metal-wood bond delamination with changes in moisture content of only a few percent due to the difference in hygro-expansion and stiffness between the wood and the reinforcing materials.

FRP has been used in a number of ways to improve durability of wood-non-wood composites. For example, FRP has been used for beam reinforcement, as face material of wood-core sandwich panels, as external reinforcement for plywood, and in the form of prestressing strands. Unlike steel and aluminum reinforcement, FRP reinforcement of wood composites can be successful because the physical/mechanical/chemical properties of FRP are very versatile. The FRP may be engineered to match and complement the orthotropic properties of wood, minimizing the incompatibility problems between the wood and the reinforcing FRP.

Prior reinforcement for wood structures with FRP has been centered on pultruded plates (U.S. Pat. Nos. 5,498,460 and 5,362,545 issued to Tingley) which are pre-consolidated and introduced into the wood component for added strength and stiffness. In spite of their adequacy and promise, these pultruded FRP composites have many disadvantages as reinforcements for wood components and structures. First, pultrusion adds cost as the FRP is pre-manufactured by a third party then re-introduced into the wood member, causing an extra step in the manufacturing process. Second, pultrusion composites have to be specially treated so that they can be later bonded to the wood. Examples of these are the “hairing-up” of fibers near the surface, as in U.S. Pat. No. 5,498,460, the formation of surface recesses, as in U.S. Pat. No. 5,362,545, or by microsealinh as in U.S. Pat. No. 5,736,220. These treatments adds to the manufacturing cost and require additional quality control to insure that the product surface is ready to be bonded. Third, dimensional tolerances on pultruded products must be such that the thickness variations are significantly less than 0.004 inches if conventional laminating (non gap-filling) adhesives are to be used. These tight tolerances to allow bonding of the FRP to the wood or bonding of the FRP to other FRP panels also add to the manufacturing and quality control costs. Fourth, shipment and handling of the pultruded FRP requires further care and added cost as the surface of the pultruded FRP panels must be protected to maintain the characteristics necessary for bonding to the wood. Fifth, centering of the pultruded FRP in a wood beam complicates the manufacture of the wood hybrid and adds cost. Though the use of a sacrificial edge may ease this problem, the use of sacrificial edges also add to the cost of the pultrusion process. Finally, pultrusion is a slow process (3-5 ft/min) that limits the rate of production of the FRP-wood hybrid, further increasing the cost of the hybrid.

In recent years a number of researchers have investigated wood reinforcement using pre-processed solid FRP systems such as pultruded plates. However the disadvantages listed above still prevail. There is not found in the prior art a simple, inexpensive, commercially viable method of combining the fabrication of the FRP reinforcement and the structural wood composites in the same process.

The present invention is directed to the consolidation of the manufacturing of both the FRP reinforcement and the remaining wood portions of the composite into one process. The incorporation of the FRP reinforcement is achieved by immersing synthetic fibers into a wet resin/solvent bath and introducing FRP composite into a structural wood composite either in a wet-impregnated form (wetpreg), or in a semi-cured form.

Wet-impregnated synthetic fabrics, commonly referred to as “Wetpreg”, have been used and have been bonded to single wood laminations in applications such as boat building utilizing sandwich construction with a wood core. In this sandwich construction, end-grain balsa is often used to form a single wood layer sandwiched between two FRP layers. The use of Wetpreg in this application differs significantly from that of the present invention. First, the individual FRP fabrics used in the prior art processes are relatively lightweight (typically less than 40 oz/yd²) and are cured under conditions that do not require simultaneously curing of multiple wood-to-wood bond lines. Second, in wood-fiberglass boat construction, the wood-to-FRP bond lines are only required to pass about 500 psi shear strength, which is inadequate in many structural applications. Third, the fabrics used in this process are not tensioned to improve alignment and strength, making them unsuitable for structural uses. Finally, the thickness of the consolidated FRP are typically small (less than ¼inch), making them far too thin for use in structural applications.

A method of cost-effectively producing large reinforced structural wood composites that provides a high throughput rate, is less process sensitive than pultrusion, and that provides composites having both the mechanical and durability properties needed for structural applications is not known in the art.

### SUMMARY OF THE INVENTION

The present invention is a method of making a fiber-reinforced polymer (FRP) used to reinforce a wood composite member, and a reinforced wood composite utilizing the same, in which the resulting composite may be consolidated and substantially cured at the same time as the wood-wood bond lines; avoiding the extra step and extra cost of separately curing the FRP and the wood-wood bond lines.

In its most basic form, the method of manufacturing FRP-wood composites of the present invention includes drawing fiber reinforcements in tension, combining the reinforcements into a dry fiber reinforcement layer, wetting the dry fiber reinforcement layer with a wet resin to form a wetted fiber reinforcement layer, building a wet FRP-wood laminate on the wood substrate, consolidating the FRP-wood laminate, and fully curing the FRP-wood hybrid. In the preferred embodiment, the wetted fiber reinforcement layer may be partially cured prior to consolidation and full curing with wood substrates.

In some embodiments, the fiber reinforcement layer is pulled through a system of nip-rolls, which spreads the impregnating resin uniformly on the fibers and ensures impregnation of the fabrics. The gap between the nip-rolls is controlled to obtain the required amount of fiber/resin content. Impregnating resins suitable for use with present invention include phenolic, epoxy, polyester, vinyl ester, ISOSET, polyurethane, and thermoplastics, with each capable of being applied as liquid and solvent diluted compositions. Synthetic fibers suitable for use with present invention include fiberglass, carbon, graphite and aramid fibers or any other fibers. These fiber reinforcements may be in the form of roving, collimated fibers, woven or stitched fabrics, tapes, or broadgoods.

Once impregnated with resin, the FRP composite reinforcement may be introduced under a desired amount of tension in its wet form on or between layers of wood consisting of solid sawn lamination, veneers or strands which are then compacted under predetermined pressure and temperature to cure both the FRP composite and the adhesive between the wood layers resulting in a simultaneously cured FRP-wood hybrid. The wet impregnated reinforcement may be applied on the wood as a single layer or as multiple layers.

In one embodiment of the invention, the synthetic reinforcement is pre-impregnated with a resin and partially cured (B-staged) using a solvent-coating process before it is introduced on the wood for final cure. The partial cure, which is similar to prepregging, is used to improve the drape and the handling of the FRP composite prior to its application on the wood substrate. In this embodiment, partial curing is accomplished by immersing the synthetic reinforcement into a bath containing 20 to 50% of a solvent and resin mixture and then drying the reinforcement in an oven. The reinforcement is then applied on the wood laminations or veneers or strands in single or multiple layers for final consolidation and cure simultaneously with the wood-to-wood adhesive bond lines. In this embodiment, an adhesive or a primer can be applied on the wood substrate to improve the bond between the wood and the FRP. In addition to improving handling of the reinforcement prior to final consolidation, the partial cure process reduces resin waste and improves the mechanical properties of the resulting wood composite.

In the preferred embodiment of the invention, no adhesive is required between the FRP and the wood substrates. That is, the FRP resin will act as a bulk matrix for the FRP reinforcement and as an adhesive bonding the reinforcement to the wood. In another embodiment of the invention a thin adhesive layer or primer is applied on the wood substrate to interact with the FRP system of the present invention when it is used in its partially cured condition to enhance the chemical bond during final consolidation.

In some embodiments, the present invention is used to reinforce glulam beams, LVL beams, PSL beams, LSL beams, I-joists, or flat composite panels such as plywood or OSB. In these embodiments, the simultaneous consolidation and curing of the FRP and the wood layers provides a strong bond between the reinforcement and the wood.

The reinforcement technology of the present invention virtually eliminates the stated difficulties and added expenses of prior art methods. It places virtually all quality control responsibility back into the wood composite manufacturing facility, eliminating and reducing costly quality control requirements on pre-cured panels, such as pultruded panels. Costs are further reduced by allowing wood manufacturers to purchase synthetic fibers and resins in the open market without paying the markup cost added by pre-manufacturing the FRP. As the present invention allows the FRP matrix and the adhesives used to bond the wood to wood to be cured simultaneously, the extra costs required to pre-cure the FRP and surface treat the pre-consolidated FRP to enhance its later bonding to the wood substrate are also eliminated. Finally, the present invention increases the speed at which the synthetic fibers can be properly impregnated, increases the thickness of the FRP that can be properly cured under the same conditions as the wood-to-wood glue lines, and enhances the mechanical properties that can be achieved.

Therefore, it is an aspect of the invention to provide a method for reinforcing a wood composite that is suitable for use with glued laminated beams, LVL beams, PSL beams, LSL beams, I-joists, or flat composite panels such as OSB and plywood.

It is another aspect of the invention to provide a method for reinforcing a wood composite that uses common wood adhesives.

It is another aspect of the invention to provide a method for reinforcing a wood composite that meets or exceeds the strength and durability requirements of ANSI/AITC/ASTM or APA requirements.

It is another aspect of the invention to provide a method for reinforcing a wood composite that meets or exceeds the strength and durability requirements of ANSI/AITC 190.1 and AITC 200.

It is another aspect of the invention to provide a method for reinforcing a wood composite that has inner core portions of the reinforcement having resin systems such as phenolic, epoxy, polyester, vinylester, ISOSET, polyurethane and thermoplastics.

It is another aspect of the invention to provide a method for reinforcing a wood composite where the matrix of the FRP reinforcement acts as an adhesive between the reinforcement and the wood.

It is a still further aspect of the invention to provide a method for reinforcing a wood composite that may be used with any type of synthetic fibers such as glass, aramid, carbon, etc or any combination of these fibers.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a process diagram of one embodiment of the method of the present invention in which dry fibers or fabrics are wetted, layered and simultaneously cured with glulam beams.

FIG. 2 is a process diagram of one embodiment of the method of the present invention in which dry fibers or fabrics are wetted, layered and simultaneously cured with flat sheets such as veneer, OSB and plywood.

FIG. 3 is a process diagram of one embodiment of the method of the present invention in which dry fibers or fabrics are drawn through a resin/solvent bath, partially cured in a drying oven, layered, and simultaneously consolidated with glulam beams.

FIG. 4A is a process diagram of one embodiment of the method of the present invention in which a thick prepreg is rolled up for later use to reinforce a wood composite

FIG. 4B is a process diagram of one embodiment of the method of the present invention in which the thick prepreg of FIG. 4a is utilized to rapidly produce thick B-staged FRP-wood composites having increased inter-laminar strength.

FIG. 5 is a process diagram of one embodiment of the method of the present invention in which a thick prepreg is utilized without rolling for later use.

FIG. 6 is a process diagram of one embodiment of the method of the present invention in which no partial curing or needle rolling of the FRP-composite is performed.

### DETAILED DESCRIPTION OF THE INVENTION

The present invention is a fiber-reinforced polymer wood hybrid composite in which the FRP reinforcement is consolidated and substantially cured at the same time as the multiple wood-wood bond lines. The wood may consist of solid sawn laminations, veneers, strands or flakes. The process of the present invention utilizes the reinforcement resin both as a bulk resin for encapsulating, bonding and protecting the fibers in the FRP, and as an adhesive for bonding the FRP to the wood composite. The simultaneous consolidation and cure provides enhanced bonding between the reinforcement and the wood and enhanced mechanical properties of the FRP-wood hybrid.

Referring first to FIG. 1, one embodiment of the method of the present invention is shown. In the first step in this embodiment, dry fiber rovings, mats, or fabrics 2, are drawn under tension from creels 1 and brought together to form a fiber reinforcement layer 3 made up of mostly unidirectional fibers. Suitable fiber reinforcement materials include fiberglass, aramid, carbon, or polyester fibers such as polyethylene and SPECTRA disposed as a stitched fabric, a woven fabric, longitudinal fibers stitched over a chopped mat, longitudinal fibers stitched over a polyester veil or through any other known methods of preassembling fibers.

Once drawn together, the fiber reinforcement layer 3 may pass directly through a series of nip-rolls 5 that spread wet resin uniformly over the fibers or the fabric. However, in the embodiment of FIG. 1 the fiber reinforcment layer 3 first passes through a roller-needle 4 to create perforations in the fiber reinforcement layer 3 to improve wetting of the resin to be applied and to introduce transverse z-direction fibers into the layer 3 to enhance interlaminar shear strength of the FRP reinforcement. The fiber reinforcement layer 3 is then drawn through the series of nip-rolls 5 to uniformly spread the resin. Suitable resins for use in this step include phenolic, epoxy, polyester, vinyl ester, ISOSET, polyurethane, and thermoplastics, with each capable of being applied as liquid and solvent diluted compositions.

Once wetted, the FRP composite passes through a partial curing zone 6 to advance the resin cure and provide a tacky partially cured FRP composite 7 that can be fully cured under the same conditions as the wood-to-wood bond lines 11 of the FRP-wood composite. The necessary degree of partial curing in zone 6 is a function of the resin used, FRP thickness, line speed, and processing/cure parameters of the wood composite product, and can be obtained by experimentation and/or process modeling methods. It should be noted that, for room-temperature cure resins, no partial curing is necessary to simultaneously fully cure the FRP-to-wood and wood-to-wood bond lines. However, other resins may require some degree of partial curing be performed in order to allow the FRP to fully cure under the same conditions as the wood-to-wood bond lines. Partial curing may be accomplished in many different manners, for example by heating in an oven, through exposure to light energy, or through exposure to radio frequency energy.

After a suitable partial cure, or “B-staging”, the FRP composite is then stacked into an uncured wood composite such as glued-laminated beam 11 to form an FRP-wood laminate. The uncured wood laminate may include sawn lumber, veneers, flakes or strands with an adhesive disposed over the top and bottom surfaces of the wood portions. The yet uncured FRP-wood laminate is then consolidated under pressure 8 and fully cured. The curing step may include radio frequency (RF) curing of the entire FRP-wood laminate in a chamber 9 to accelerate cure rate, though a room-temperature cure may also be employed provided appropriate catalysts to the FRP resin are used.

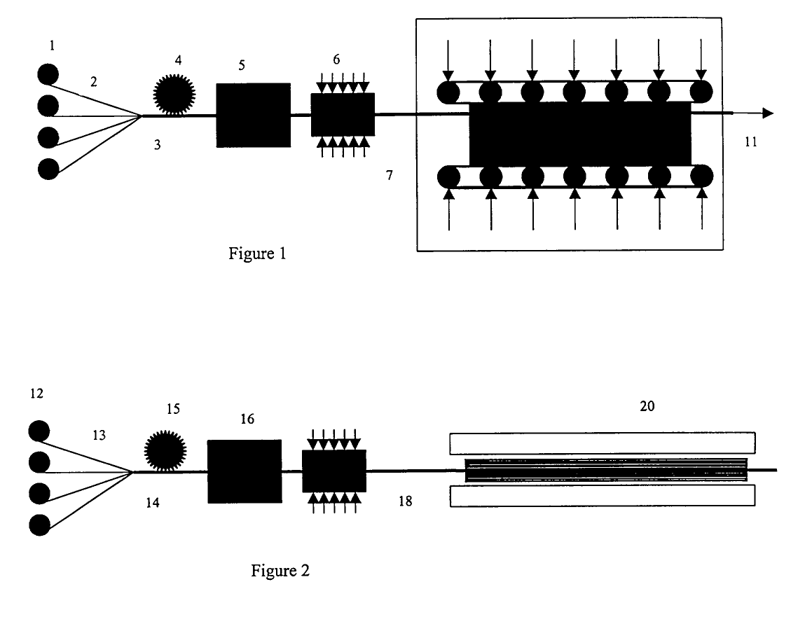

Referring now to FIG. 2, another embodiment of the method of the present invention is shown. As was the case with the method of FIG. 1, dry fibers, fabrics, or the like 13, are drawn from creels 12 to form a fiber reinforcement layer 14. The fiber reinforcement layer 14 is passed through a roller-needle 15 and drawn through a series of nip-rolls 16, which spread wet resin uniformly over the fibers or the fabric. The wet FRP composite is then partially cured and layered onto or between wood panels as in the embodiment of FIG. 1. However, rather than simply pressure curing or RF curing the uncured FRP-wood laminate, in this embodiment the FRP-wood laminate is subjected to pressure and temperature in a hot press 20 or the like to cure the adhesive between the wood layers and substantially completes the cure of the matrix of the FRP composite. The appropriate amounts of pressure and temperature to be applied will depend on the type of wood panels and resins used

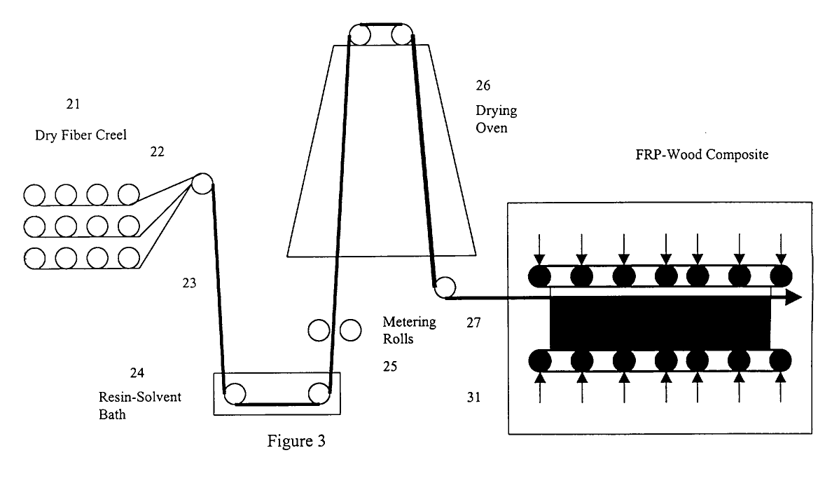

Referring now to FIG. 3, another embodiment of the method of the present invention is shown. In the method of FIG. 3, dry fibers or fabrics 22, are drawn from creels 21 to form a fiber reinforcement layer 23. The fiber reinforcement layer 23 passes through a resin-solvent bath 24 where the fibers or fabrics are thoroughly coated with resin for good wetting. The fiber reinforcement layer 23 is then drawn through a series of metered rolls 25, which control the amount of the wet resin and spreads it uniformly over the fibers or the fabric. The wet FRP composite goes through a hot oven 26 to partially cure the resin and provides an FRP prepreg composite 27 that can easily be handled, stacked and laid-up over the wood composite. The FRP composite then proceeds to be layered onto or between wood and the FRP-wood laminate is simultaneously pressured and cured.

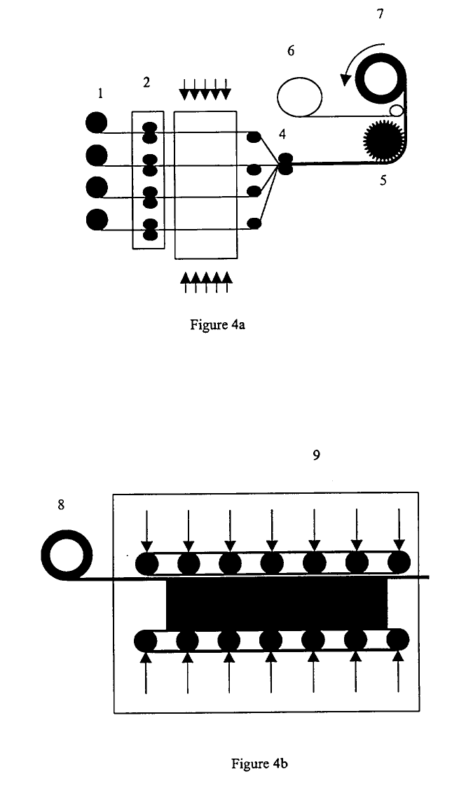

Referring now to FIGS. 4A and 4B, another embodiment of the method of the present invention, particularly suited for the production of reinforced glulam beams where relatively thick reinforcements are needed, is shown. In this embodiment, a series of dry fiber rovings and/or fabrics are drawn under tension from creels 1 into a series of thin fiber reinforcement layers to allow rapid and thorough wetting and rapid B-staging of the resin. The thin layers are passed through a resin solvent bath 2 where the fibers and/or fabrics are thoroughly coated with a predetermined resin/solvent to enhance wetting of the fibers. Once coated, the thin fiber reinforcement layers are wetted with resin, preferably by drawing them through a series of metered rolls to control the amount of the wet resin and spreading the resin uniformly over surfaces of the fiber reinforcement layers. The thin layers of wetted FRP composite are then individually partially cured and collected 4 to form a composite of the desired thickness for reinforcing the glulam beam. The tensioned fiber reinforcement layer may now pass through a roller-needle and a release film 6 may be applied to allow the B-staged thick composite to be rolled up 7 for later use.

As shown in FIG. 4B, one or more of these relatively thick layers of thick composite 8 may be laid up under tension onto the tension side of a glulam beam and then subjected to temperature (or RF) and pressure 9 to cure the adhesive between the wood layers and the matrix of the FRP composite. In this embodiment, the use of relatively thin layers of composite allows later curing and consolidation of the FRP under the same conditions of the wood-to-wood bond lines and provides an FRP prepreg composite that can easily be handled, stacked and laid-up over the wood composite. In this embodiment, thorough wetting and rapid production are accomplished by using thin layers of dry fibers which are individually wetted, individually partially cured, and brought back together.

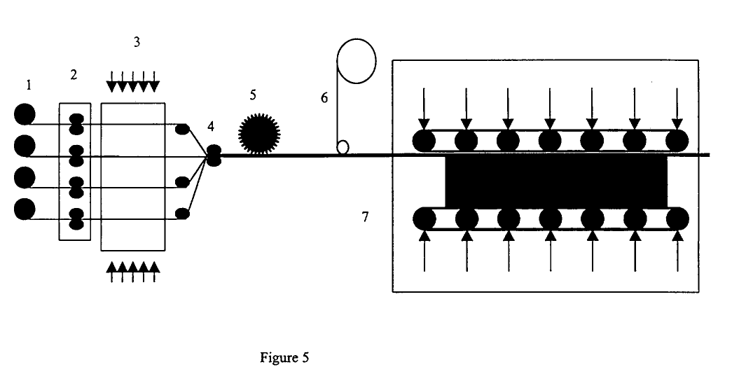

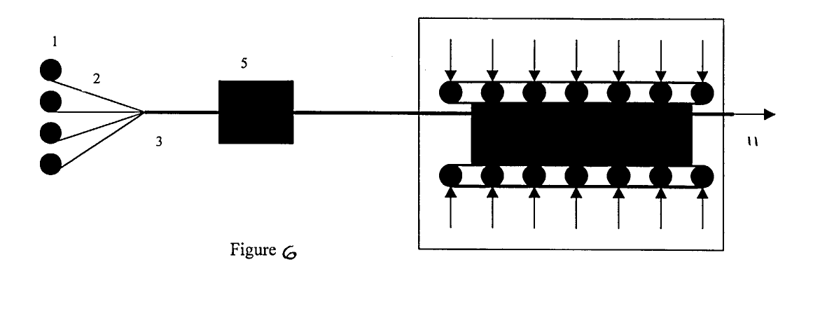

Referring now to FIG. 5, yet another embodiment of this invention is shown. This method includes the same steps as those described with reference to FIGS. 4A and 4B, except that the thick fiber reinforcement layer is not coated with a release film and rolled up for later use. Rather, in this embodiment the thick fiber reinforcement layer is immediately introduced into the glulam beam 7 which allows for the production of beam and curing of the entire system in a continuous process. This is particularly useful for FRP resins that cannot be efficiently stored at room temperature in an advanced stage.

Referring now to FIG. 6, another embodiment of the method of the present invention is shown. The method of FIG. 6 includes the steps of drawing dry fiber rovings, mats, or fabrics 2 under tension from creels 1, bringing the fabrics together to form a fiber reinforcement layer 3 made up of mostly unidirectional fibers. The fiber reinforcement layer 3 then passes directly through a series of nip-rolls 5 that spread wet resin and a suitable catalyst uniformly over the fibers or the fabric. Then, rather than partially curing the wetted fiber reinforcement layer, the wetted layer is immediately stacked into an uncured wood composite such as glued-laminated beam 11 to form an FRP-wood laminate and consolidated under pressure. The resulting FRP-wood composite is then allowed to simultaneously fully cure at room temperature.

It should be noted that one aspect of this invention, which is particularly useful in the production of glued-laminated beams, is the ability to use common inexpensive phenol resorcinol formaldehyde (PRF) adhesives, such as commonly used in bonding glulam beams, as a matrix for the FRP reinforcement as well as the adhesive that allows the impregnated reinforcement to bond to the wood substrate. In the preferred emboidment, the PRF adhesive is modified by adding a caustic solution of 0.15%+/−0.1-0.2% by volume to achieve maximum bonding.

Experimentation has shown that improved wetting of the FRP dry fibers, improved FRP-wood shear strength, and improved cycle-delamination resistance of the FRP-wood bond line can be achieved by adding a small amount of caustic solution into the PRF adhesive. Thus, it is feasible to pass AITC 200 and AITC 190.1 cycle-delamination and shear strength requirements using the process of the present invention when caustic is added to the PRF adhesive. This is an important development since this resin is already available in glued-laminating facilities and is used to bond the wood laminations together.

Finally, it should be noted that any of the methods of the present invention may be adapted into a continuous process in which the wet or partially cured FRP is produced, introduced into the yet uncured wood composite, consolidated, and cured in one step.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A method of making a partially cured FRP composite for consolidation and substantially simultaneous curing with at least one uncured wood composite, said method comprising the steps of:
drawing a plurality of fiber reinforcements in tension;
combining said plurality of fiber reinforcements into a dry fiber reinforcement layer;
wetting said dry fiber reinforcement layer with a predetermined wet resin to form a wetted fiber reinforcement layer;
partially curing said wetted fiber reinforcement layer to form the partially cured FRP composite, said partial curing being to a degree sufficient to allow said partially cured FRP composite to be fully cured substantially simultaneous with at least one uncured wood composite.

2. The method as claimed in claim 1 further comprising the step of combining a plurality of partially cured FRP composites together after said partial curing step to form a composite of predetermined thickness.

3. The method as claimed in claim 1 further comprising the step of applying a release film to said partially cured FRP composite.

4. The method as claimed in claim 3 further comprising the step of rolling said partially cured FRP composite after applying said release film.

5. The method as claimed in claim 1 further comprising the step of needle-rolling said dry fiber reinforcement layer to create z-direction fibers in said dry fiber reinforcement layer.

6. The method as claimed in claim 1 further comprising the step of needle-rolling said partially cured FRP composite to create perforations and z-direction fibers in said composite.

7. The method as claimed in claim 1 wherein said wetting step comprises substantially uniformly wetting said dry fiber reinforcement layer with a predetermined wet resin to form a wetted fiber reinforcement layer.

8. The method as claimed in claim 7 wherein said wetting step comprises drawing said dry fiber reinforcement layer through a series of nip-rolls that spread wet resin uniformly over said dry fiber reinforcement layer.

9. The method as claimed in claim 1 wherein said pre-curing step is performed by a method selected from the group consisting of heating said wetted fiber reinforcement layer in an oven, exposing said wetted fiber reinforcement layer to light energy, and exposing said wetted fiber reinforcement layer to radio frequency energy.

10. The method as claimed in claim 1 wherein said wetting step comprises wetting said dry fiber reinforcement layer with a phenol resorcinol formaldehyde adhesive.

11. The method as claimed in claim 10 wherein said wetting step comprises wetting said dry fiber reinforcement layer with a phenol resorcinol formaldehyde adhesive modified by the addition of a predetermined amount of a caustic solution.

12. The method as claimed in claim 1 wherein said step of drawing a plurality of fiber reinforcements in tension comprises rolling fiber reinforcements selected from a group consisting of a stitched fabric, a woven fabric, longitudinal fibers stitched over a chopped mat, and longitudinal fibers stitched over a polyester veil, and wherein said fibers forming said fiber reinforcement layer are selected from a group consisting of fiberglass, aramid fibers, carbon fibers, and polyester fibers.

13. A method of manufacturing reinforced wood composites comprising the steps of:
drawing a plurality of fiber reinforcements in tension;
combining said plurality of fiber reinforcements into a dry fiber reinforcement layer;
wetting said dry fiber reinforcement layer with a predetermined wet resin to form a wetted fiber reinforcement layer;
partially curing said wetted fiber reinforcement layer to form a partially cured FRP composite for consolidation and substantially simultaneous curing with at least one uncured wood composite;
introducing said partially cured FRP composite into an uncured wood composite laminate to form an FRP-wood laminate;
consolidating said FRP-wood laminate; and
curing said consolidated FRP-wood laminate to form said reinforced wood composite.

14. The method as claimed in claim 13 further comprising the step of needle-rolling said dry fiber reinforcement layer to create z-direction fibers in said dry fiber reinforcement layer.

15. The method as claimed in claim 13 wherein said wetting step comprises substantially uniformly wetting said dry fiber reinforcement layer with a predetermined wet resin to form a wetted fiber reinforcement layer.

16. The method as claimed in claim 15 wherein said wetting step comprises drawing said dry fiber reinforcement layer through a series of nip-rolls that spread wet resin uniformly over said dry fiber reinforcement layer.

17. The method as claimed in claim 13 wherein said partial curing step is performed by a method selected from the group consisting of heating said wetted fiber reinforcement layer in an oven, exposing said wetted fiber reinforcement layer to light energy, and exposing said wetted fiber reinforcement layer to radio frequency energy.

18. The method as claimed in claim 13 wherein said curing step is performed by a method selected from the group consisting of heating said FRP-wood composite in an oven, exposing said FRP-wood composite to light energy, and exposing said FRP-wood composite to radio frequency energy.

19. The method as claimed in claim 13 wherein said wetting step comprises wetting said dry fiber reinforcement layer with a phenol resorcinol formaldehyde adhesive.

20. The method as claimed in claim 13 wherein said wetting step comprises wetting said dry fiber reinforcement layer with a phenol resorcinol formaldehyde adhesive modified by the addition of a predetermined amount of a caustic solution.

21. The method as claimed in claim 13 wherein said step of drawing a plurality of fiber reinforcements in tension comprises rolling fiber reinforcements selected from a group consisting of a stitched fabric, a woven fabric, longitudinal fibers stitched over a chopped mat, and longitudinal fibers stitched over a polyester veil, and wherein said fibers forming said fiber reinforcement layer are selected from a group consisting of fiberglass, aramid fibers, carbon fibers, and polyester fibers.
